(19) United States
(12) Patent Application Publication
(10) Pub. No.: US 2022/0268591 A1
(43) Pub. Date: Aug. 25, 2022

(54) Method, Computer Program, and Device for Processing Data Recorded by a Motor Vehicle

(71) Applicant: Volkswagen Aktiengesellschaft, Wolfsburg (DE)

(72) Inventors: Stephan Max, Gifhorn (DE); Martin Wegner, Braunschweig (DE); Sabina Alazzawi, München (DE); Richard Niestroj, München (DE)

(73) Assignee: Volkswagen Aktiengesellschaft, Wolfsburg (DE)

(21) Appl. No.: 17/623,004

(22) PCT Filed: May 20, 2020
(86) PCT No.: PCT/EP2020/064087

§ 371 Date: Dec. 27, 2021

(30) Foreign Application Priority Data
Jun. 26, 2019 (DE) 10 2019 209 226.8

(51) Int. Cl. G01C 21/34; G01C 21/36

(52) U.S. Cl. CPC G01C 21/3461; G01C 21/3446; G01C 21/3641

(57) ABSTRACT

The invention relates to a method, to a computer program with instructions, and to a device for processing data recorded by a motor vehicle. The invention additionally relates to a motor vehicle and to a back end in which a method according to the invention or a device according to the invention is used. In a first step, data recorded along a route traversed by the motor vehicle are received. The recorded data are then divided into segments of the traversed route, each of the segments being separated by a gap. Additionally, a spatial obfuscation is applied to the data of the segments of the traversed route. The obfuscated data are finally forwarded for further processing. The segmentation and the spatial obfuscation may be carried out within the motor vehicle or in a back end connected to the motor vehicle.

### CROSS-REFERENCE TO RELATED APPLICATIONS

This application claims priority to German Patent Application No. DE 10 2019 209 226.8, filed Jun. 26, 2019 with the German Patent and Trademark Office. The contents of the aforesaid Patent Application are incorporated herein for all purposes.

### TECHNICAL FIELD

The present invention relates to a method, a computer program with instructions, and a device for processing data recorded by a motor vehicle. The invention further relates to a motor vehicle and a back end in which a method according to the invention or a device according to the invention is used.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In modern motor vehicles, a variety of data is collected. With increasing vehicle connectivity, there is an interest in using the data collected by a vehicle for further evaluation. For this purpose, data may be taken from the motor vehicle and fed to a back end. For example, data may be extracted from vehicle sensors in a location- or time-dependent manner for applications relating to weather forecasts, parking space occupancy, or traffic flow data. In the back end, the data are then combined with other data on a map and fed back to the functions using said data.

One application scenario for data collection is the creation of a database for anonymized swarm data for researching, developing, and safeguarding automatic driving functions. Highly automated vehicles are expected to cope with a plethora of different and sometimes complex road traffic scenarios without there being an accident. However, since the majority of these scenarios occur only very rarely, testing in real road traffic is both time- and cost-intensive. A substantial database is therefore required for the development of automatic driving functions to series maturity in order to safeguard the algorithms, as this may no longer be achieved by means of classic endurance test runs. Therefore, a data pool is required which has data from as wide a variety of challenging traffic situations as possible, ideally supplied from real driving situations, by means of which data pool the algorithms may be trained and continuously improved such that the vehicles may make appropriate decisions and act safely in road traffic in all eventualities.

However, the data taken from a vehicle may sometimes provide an indication of the personal or material circumstances of an identified or at least identifiable natural person, for example the driver of the motor vehicle.

Such collection and use of the data is generally only possible with a declaration of consent of the relevant person, as per applicable data protection regulations. Although consumers today, in particular in the software field, are quite familiar with accepting conditions of use and granting approval for the evaluation of data, this is not very common in the automotive sector. It is therefore not always easy to obtain a declaration of consent for the use of the data. In addition, software updates may potentially require a new declaration of consent to be obtained from the user, which could become a nuisance for the user over time.

In order to ensure the protection of data, the data may be subjected to different anonymization methods. The aim of these anonymization methods is to conceal the identity of the data originator in an anonymization group.

### SUMMARY

A need exists to provide solutions for processing data recorded by a motor vehicle that enables segmentation of data recorded along a traversed route with reduced gaps between the segments.

The need is addressed by a method, by a computer program, and by a device having the features of the independent claims.

Embodiments of the invention are described in the dependent claims, the following description, and the drawings.

### BRIEF DESCRIPTION OF THE DRAWINGS

FIG. 1 schematically shows an exemplary method for processing data recorded by a motor vehicle;

FIG. 2 shows a first embodiment of a device for processing data recorded by a motor vehicle;

FIG. 3 shows a second embodiment of a device for processing data recorded by a motor vehicle;

FIG. 4 is a schematic representation of a motor vehicle in which an embodiment is implemented; and

FIG. 5 illustrates routes traversed and the division thereof into segments.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for processing data recorded by a motor vehicle comprises:
receiving data recorded along a route traversed by the motor vehicle;
dividing the recorded data into segments of the traversed route, each of the segments being separated by a gap;
applying a spatial obfuscation to the data of the segments of the traversed route; and
forwarding the obfuscated data for further processing.

In some embodiments, a computer program contains instructions which, when executed by a computer, prompt the computer to carry out the following steps for processing data recorded by a motor vehicle:
receiving data recorded along a route traversed by the motor vehicle;
dividing the recorded data into segments of the traversed route, each of the segments being separated by a gap;
applying a spatial obfuscation to the data of the segments of the traversed route; and
forwarding the obfuscated data for further processing.

The term “computer” is to be understood broadly. In particular, it may also include control units, workstations, and other processor-based data processing devices.

The computer program may for example be provided for electronic retrieval or be stored on a computer-readable storage medium.

In some embodiments, a device for processing data recorded by a motor vehicle comprises:
an input for receiving data recorded along a route traversed by the motor vehicle;
a data processing unit for dividing the recorded data into segments of the traversed route, each of the segments being separated by a gap;
an anonymization unit for applying a spatial obfuscation to the data of the segments of the traversed route; and
an output for forwarding the obfuscated data for further processing.

In the solution, the division of the recorded data into segments is combined with a spatial obfuscation. This significantly increases the probability of only segments with non-recombinable signals being present. As a result, the gaps between the segments may be kept small, which is desirable from a data collection point of view, without it being necessary to increase the size of the required anonymization group, which could otherwise significantly limit the usefulness of the data.

In some embodiments, the spatial obfuscation is applied for each segment individually. For this purpose, start points of the segments are shifted by a noise value from a noise interval. In this way, the desired spatial obfuscation may be implemented in a simple manner.

In some embodiments, lengths of the gaps between the segments are selected randomly from a length interval. This ensures that successive segments are independent of one another. Otherwise, in the event of gaps of a constant length, it could be established whether segments come from the same vehicle by evaluating the start and end points of the segments.

In some embodiments, a temporal obfuscation is additionally applied to the data of the segments of the traversed route. This measure leads to a greater increase in group anonymity.

In some embodiments, an originally required group size of an anonymization group is increased by a correction factor that takes into account that the application of the spatial obfuscation takes place in combination with division of the recorded data into segments of the traversed route. The noise interval for the spatial obfuscation may be taken into account within the framework of a correction factor by means of which a corrected group size may be calculated. Although said correction factor approaches the value of one with increasing size of the noise interval, the correction factor should not be neglected in view of the importance of group anonymity.

For example, a method according to the teachings herein or a device according to the teachings herein may be used in an autonomously or manually controlled vehicle, in particular a motor vehicle. Alternatively, the solution may also be used in a back end to which the data is transmitted from the vehicle.

Additional features of the present invention will become apparent from the following description and the appended claims in conjunction with the FIGS.

In order to improve understanding of the principles of the present invention, further embodiments of the invention will be explained in detail in the following based on the FIGS. It should be understood that the invention is not limited to these embodiments and that the features described may also be combined or modified without departing from the scope of protection of the invention as defined in the appended claims.

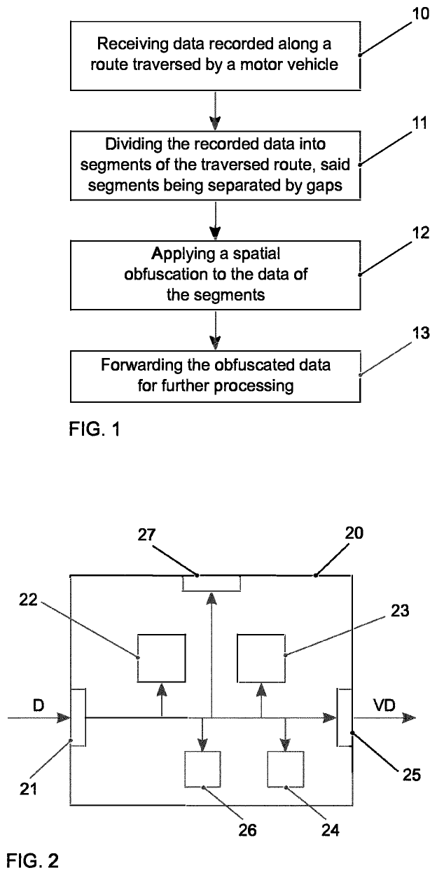

FIG. 1 schematically shows a method for processing data recorded by a motor vehicle. In a first step, data recorded along a route traversed by the motor vehicle are received 10. Subsequently, the recorded data are divided 11 into segments of the traversed route. The segments are separated from one another in each case by means of a gap. The lengths of the gaps between the segments may be randomly selected from a length interval. Furthermore, a spatial obfuscation is applied 12 to the data of the segments of the traversed route. In the process, start points of the segments may be shifted by a noise value from a noise interval. For example, the spatial obfuscation is applied for each segment individually. Additionally, a temporal obfuscation may be applied to the data of the segments of the traversed route. Finally, the obfuscated data are forwarded 13 for further processing. For example, the fact of the segmentation and spatial obfuscation being combined with one another is taken into account in that an originally required group size of an anonymization group is increased by a correction factor.

FIG. 2 is a simplified schematic representation of a first embodiment of a device 20 for processing data recorded by a motor vehicle. The device 20 comprises an input 21 for receiving data D recorded along a route traversed by the motor vehicle. A data processing unit 22 divides the recorded data D into segments of the traversed route. The segments are separated from one another in each case by means of a gap. The lengths of the gaps between the segments may be randomly selected from a length interval. An anonymization unit 23 then applies a spatial obfuscation to the data D of the segments of the traversed route. In the process, start points of the segments may be shifted by a noise value from a noise interval. For example, the spatial obfuscation is applied for each segment individually. The parameters required for the spatial obfuscation may for example be determined and provided by the data processing unit 22. The anonymization unit 23 may additionally be configured to apply a temporal obfuscation to the data of the segments of the traversed route. Finally, the obfuscated data VD are forwarded for further processing via an output 25. For example, the fact of the segmentation and spatial obfuscation being combined with one another is taken into account in that an originally required group size of an anonymization group is increased by a correction factor.

The data processing unit 22 and the anonymization unit 23 may be controlled by a control unit 24. Settings of the data processing unit 22, anonymization unit 23, or control unit 24 may be changed, if required, via a user interface 27. The data accumulating in the device 20 may be deposited in a memory 26 of the device 20 if required, for example for later evaluation or to be used by the components of the device 20. The data processing unit 22, anonymization unit 23, and control unit 24 may be designed as dedicated hardware, for example as integrated circuits. Of course, they may also be partially or fully combined or be implemented as software running on a suitable processor, for example a GPU. The input 21 and the output 25 may be implemented as separate interfaces or as a combined bidirectional interface.

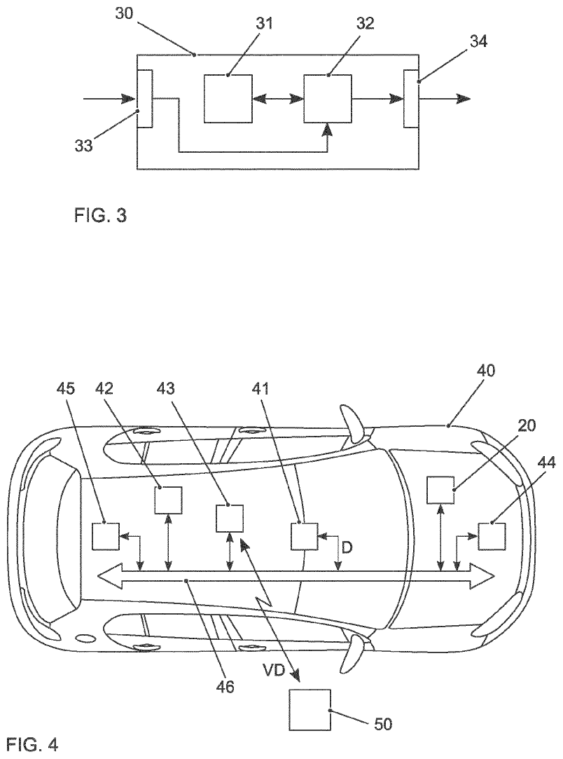

FIG. 3 is a simplified schematic representation of a second embodiment of a device 30 for processing data recorded by a motor vehicle. The device 30 comprises a processor 32 and a memory 31. By way of example, the device 30 is a computer, a workstation, or a control unit. Instructions which, when executed by the processor 32, prompt the device 30 to carry out the steps according to any one of the methods described are stored in the memory 31. The instructions stored in the memory thus constitute a program that may be executed by the processor 32 and that implements the method according to the teachings herein. The device has an input 33 for receiving information. Data generated by the processor 32 are provided via an output 34. Said data may also be stored in the memory 31. The input 33 and the output 34 may be merged into a bidirectional interface.

The processor 32 may comprise one or more processor units, for example microprocessors, digital signal processors, or combinations thereof.

The memories 26, 31 of the embodiments described may have volatile and/or non-volatile memory regions and comprise a wide variety of storage units and storage media, for example hard drives, optical storage media, or semiconductor memories.

The two embodiments of the device may be integrated in the motor vehicle or be part of a back end that is connected to the motor vehicle.

FIG. 4 is a schematic representation of a motor vehicle 40 in which a solution according to the teachings herein is implemented. The motor vehicle 40 comprises a sensor system 41 by means of which data D may be recorded along a route, for example a traffic situation. Other components of the motor vehicle 40 are a navigation system 42, a data transmission unit 43, and a series of assistance systems 44, of which one is shown by way of example. By means of the data transmission unit 43, a connection to a back end 50 may be established, in particular for transmitting recorded data. In this exemplary embodiment, a device 20 for processing the recorded data D provides for segmentation and spatial obfuscation of the data, such that obfuscated data VD are transmitted to the back end 50. Alternatively, the segmentation and obfuscation of the data D may not take place until said data are in the back end 50, before they are provided thereby to a data user. A memory 45 is present for storing data. The data exchange between the various components of the motor vehicle 40 takes place via a network 46.

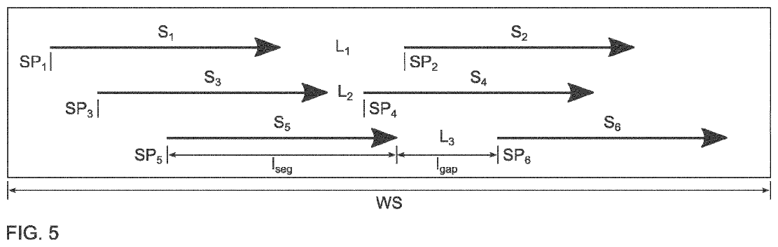

FIG. 5 illustrates traversed routes WS and the division thereof into segments S,. With a view to demonstrating the problem to be solved, in FIG. 5, a road on which three vehicles are traveling on the same road section at different points in time is assumed. The FIG. shows six segments S⋅,, i.e. two segments S⋅, per vehicle. The data of the vehicles are not only segmented with the length l_{seg}, data between the segments S⋅, are also deleted. The length l_{gap} of the gap was randomly selected in each case within an interval of the length l_{gap-rand}.

If the different obfuscated segments then need to be assigned to the original segments S⋅, the obfuscated segments may only be recombined if the end of a segment S⋅, and the start of the next segment S⋅, are at a distance within the interval of (l_{gap}−l_{gap_rand}) to (l_{gap}+l_{gap_rand}) from one another. If it is further assumed that the start points SP, of the respective segments S⋅, are randomly distributed in a uniform manner, the probability P_{ag} that only non-recombinable segments are present is defined as follows:

$${P}_{a g} = \frac{( {l}_{g a p} + {l}_{gap \_ rand} )}{{l}_{s e g} + ( {l}_{g a p} + {l}_{gap \_ rand} )} \qquad ( 1 )$$

Since the aim is to obtain as much data as possible, the gap must be kept as small as possible. Therefore (l_{gap}+l_{gap_rand})<l_{sag}. This results in a very low probability of non-recombinable segments. For example, at a segment length l_{seg} of 10 km and gap of 500 to 1000 m, only 10% of the segments are non-recombinable. In order to nonetheless achieve the anonymization group size, the number of detected vehicles and thus the size of the obfuscation would have to increase by a factor of 10. This would significantly limit the usefulness of the data.

In order to prevent this, both methods are combined with one another. For example, it is assumed that each segment S⋅, is obfuscated individually. Noise is applied to each of the start points SP, of the segments S⋅, in the form of an offset l_{rausch}. If this is taken into account in the above-mentioned relationships, the gap between the segments is increased in proportion with the noise value:

$${P}_{a g} = \frac{( {l}_{g a p} + {l}_{gap \_ rand} + {l}_{raus c h} )}{{l}_{s e g} + ( {l}_{g a p} + {l}_{gap \_ rand} + {l}_{raus c h} )} \qquad ( 2 )$$

If it is then assumed that (l_{gap}+l_{gap_rand}+l_{rausch})>l_{seg}, since the penetration of the vehicles is very low at the start in particular, the probability P_{ag} is close to one. The “penetration” is to be understood as the proportion of total vehicles involved in the data collection.

By way of example, it is assumed that a measuring vehicle from the swarm traverses the segment of a route every 10 minutes on a highway. Thus, at an assumed anonymization group size of five and a speed of 60 m/s, an obfuscation in the region of 180 km is required. This contrasts with a significantly smaller segment length of 10 km.

The two methods are now combined by means of a correction factor k_{seg} applied to the group size k of the anonymization group. The factor kₖₒᵣᵣ thus corrected is obtained as follows:

$${k}_{korr} = {k}_{s e g} \cdot k = \frac{1}{{P}_{a g}} \cdot k \qquad ( 3 )$$

Assuming that (l_{gap}+l_{gap_rand}+l_{rausch})>l_{seg} the correction factor k_{seg} approaches one. As such, by combining, there is much less influence on the corrected group size. However, this influence should for example be taken into account nonetheless.

### LIST OF REFERENCE NUMERALS

10 Receiving data recorded along a route traversed by a motor vehicle

11 Dividing the recorded data into segments of the traversed route, said segments being separated by gaps

12 Applying a spatial obfuscation to the data of the segments

13 Forwarding the obfuscated data for further processing

20 Device

21 Input

22 Data processing unit

23 Anonymization unit

24 Control unit

25 Output

26 Memory

27 User interface

30 Device

31 Memory

32 Processor

33 Input

34 Output

40 Motor vehicle

41 Sensor system

42 Navigation system

43 Data transmission unit

44 Assistance system

45 Memory

46 Network

50 Back end

D Item of data

l_{gap} Length of a gap

Lᵢ Gap

L_{seg} Length of a segment

Si Segment

SPᵢ Start point of a segment

VD Obfuscated item of data

WS Route

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfill the functions of several items recited in the claims.

The term “exemplary” used throughout the specification means “serving as an example, instance, or exemplification” and does not mean “preferred” or “having advantages” over other embodiments. The term “in particular” used throughout the specification means “serving as an example, instance, or exemplification”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for processing data recorded by a motor vehicle, comprising:
receiving data recorded along a route traversed by the motor vehicle;
dividing the recorded data into segments of the traversed route, each of the segments being separated by a gap;
applying a spatial obfuscation to the data of the segments of the traversed route; and
forwarding the obfuscated data for further processing.

2. The method of claim 1, wherein start points of the segments are shifted by a noise value from a noise interval during application of the spatial obfuscation.

3. The method of claim 1, wherein the spatial obfuscation is applied for each segment individually.

4. The method of claim 1, wherein lengths of the gaps between the segments are randomly selected from a length interval.

5. The method of claim 1, wherein a temporal obfuscation is additionally applied to the data of the segments of the traversed route.

6. The method of claim 1, wherein an originally required group size of an anonymization group is increased by a correction factor that takes into account that the application of the spatial obfuscation takes place in combination with division of the recorded data into segments of the traversed route.

7. A computer program with instructions which, when executed by a computer, prompt the computer to:
receive data recorded along a route traversed by the motor vehicle;
divide the recorded data into segments of the traversed route, each of the segments being separated by a gap;
apply a spatial obfuscation to the data of the segments of the traversed route; and
forward the obfuscated data for further processing.

8. A device for processing data recorded by a motor vehicle, comprising:
an input for receiving data recorded along a route traversed by the motor vehicle;
a data processing unit for dividing the recorded data into segments of the traversed route, each of the segments being separated by a gap;
an anonymization unit for applying a spatial obfuscation to the data of the segments of the traversed route; and
an output for forwarding the obfuscated data for further processing.

9. A motor vehicle, comprising a device according to claim 8.

10. A back end for processing data recorded by a motor vehicle, comprising a device according to claim 8.

11. The method of claim 2, wherein the spatial obfuscation is applied for each segment individually.

12. The method of claim 2, wherein lengths of the gaps between the segments are randomly selected from a length interval.

13. The method of claim 3, wherein lengths of the gaps between the segments are randomly selected from a length interval.

14. The method of claim 2, wherein a temporal obfuscation is additionally applied to the data of the segments of the traversed route.

15. The method of claim 3, wherein a temporal obfuscation is additionally applied to the data of the segments of the traversed route.

16. The method of claim 4, wherein a temporal obfuscation is additionally applied to the data of the segments of the traversed route.

17. The method of claim 2, wherein an originally required group size of an anonymization group is increased by a correction factor that takes into account that the application of the spatial obfuscation takes place in combination with division of the recorded data into segments of the traversed route.

18. The method of claim 3, wherein an originally required group size of an anonymization group is increased by a correction factor that takes into account that the application of the spatial obfuscation takes place in combination with division of the recorded data into segments of the traversed route.

19. A motor vehicle, configured to carry out the method according to claim 1.

20. A back end for processing data recorded by a motor vehicle, configured to carry out the method according to claim 1.
